(19) United States
(12) Patent Application Publication
(10) Pub. No.: US 2025/0356347 A1
(43) Pub. Date: Nov. 20, 2025

(54) SYSTEMS AND METHODS FOR USE IN UPDATING CREDENTIALS ASSOCIATED WITH AUTHENTICATION IN CONNECTION WITH NETWORK ACTIVITIES

(71) Applicant: MASTERCARD INTERNATIONAL INCORPORATED, Purchase, NY (US)

(72) Inventors: Mouly Kuchipudi, Chesterfield, MO (US); Michael James Shaon, Columbia, MO (US); Stephen Quinn, Wicklow (IE); Paul O'Regan, Arlington, VA (US)

(21) Appl. No.: 19/203,009

(22) Filed: May 8, 2025

Related U.S. Application Data
(60) Provisional application No. 63/648,605, filed on May 16, 2024.

(51) Int. Cl. G06Q 20/38; G06Q 20/40

(52) U.S. Cl. CPC G06Q 20/3821; G06Q 20/4014

(57) ABSTRACT

Systems and methods are provided for updating credentials for accounts associated with users. An example computer-implemented method includes receiving, from a first party, an authentication request for a network transaction associated with an account, the authentication request including a credential unique to the account; determining that the credential unique to the account is invalid; and in response to determining that the credential unique to the account is invalid: identifying an updated credential unique to the account; appending the updated credential unique to the account to an authentication message; and transmitting the authentication message to one of the first party and an access control server (ACS) associated with an issuer of the account.

### CROSS-REFERENCE TO RELATED APPLICATION

This application claims the benefit of, and priority to, U.S. Patent Application No. 63/648,605, filed on May 16, 2024. The entire disclosure of the above application is incorporated herein by reference.

### FIELD

The present disclosure generally relates to systems and methods for use in updating credentials associated with authentication, in connection with network activities.

### BACKGROUND

This section provides background information related to the present disclosure which is not necessarily prior art.

Often, in connection with network activities, credentials are relied on to identify users. Where the activities involve transactions, the credentials include credentials for payment accounts. Payment account credentials may become invalid for a variety of different reasons. When credentials become invalid, users and/or issuers of the credentials update or reissue the credentials for use in connection with further activities. For example, when an account number is compromised, an issuer of the account identified by the account number is known to issue a new account number for the account (eg., issuing a new credit card, etc.). In connection therewith, the user often updates the account number with one or more parties (e.g., merchants, etc.).

### BRIEF DESCRIPTION OF DRAWINGS

The drawings described herein are for illustrative purposes only of selected embodiments and not all possible implementations, and are not intended to limit the scope of the present disclosure:

FIG. 1 illustrates an example system for use in updating credentials associated with authentication, in connection with network transactions;

FIG. 2 is a block diagram of an example computing device that may be used in the system of FIG. 1; and

FIG. 3 illustrates an example method that may be implemented via the system of FIG. 1 for use in updating a credential for a payment account, as part of authentication, in connection with a network transaction.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Credentials may be used to identify different accounts including, for example, payment accounts. In connection therewith, the credentials may include payment account numbers, tokens, etc. In a variety of uses of the payment accounts, first parties (eg., merchants, etc.) receive and retain the credentials to initiate subsequent card-not-present (CN P) transactions. When a credential becomes invalid for one or more reasons (eg., fraud, expiration, etc.) (eg., which is a relatively common occurrence across hundreds of thousands, or millions, of accounts, etc.), it is inefficient and problematic for the user associated with the credential to update the credential with each of the first parties. Often, the card-not-present transaction is declined at least once, but potentially multiple times, before the user is informed and instructed to update the credential, whereupon the transaction is again submitted albeit delayed, or often potentially substantially delayed (e.g., more than one or two business days, etc.).

Uniquely, the systems and methods herein provide for updating credentials directedly within the authentication phase, in connection with transactions. In particular, in connection with enhanced authentication (or an authentication phase) for a transaction (which is different than authorization for the transaction), an authentication request is received by a directory server, and a credential associated with an account (and included in the authentication request) may be identified as invalid (for one or more various reasons as described herein). In response, the directory server identifies an updated credential associated with the account and provides the updated credential either in a response to the authentication request, or as part of the authentication request (eg., modifies the authentication request to include the updated credential, etc.). In this way, the authentication request, or an updated authentication request, is permitted to proceed whereby the authentication of the user may be successful (which includes and/or is based on the updated credential). Thereafter, authorization of the transaction may be successfully approved using the updated credential (instead of the invalid credential). As such, by way of the present disclosure, the updated credential is integrated into the enhanced authentication for the transaction, with limited or no input/interaction from the user, thereby promoting efficiency and limiting friction in connection with processing the transaction while addressing invalid credentials and incorporating the updated credential (e.g., as part of subsequent authorization of the underlying transaction, etc.). Consequently, the transaction with the invalid credential is not declined, additional transactions are not repeatedly initiated, i.e., attempts for the same transaction, which may also be declined, or ultimately approved (based on user input/interaction). The systems and method herein therefore provide for substantial reductions in network traffic, where credentials have become invalid.

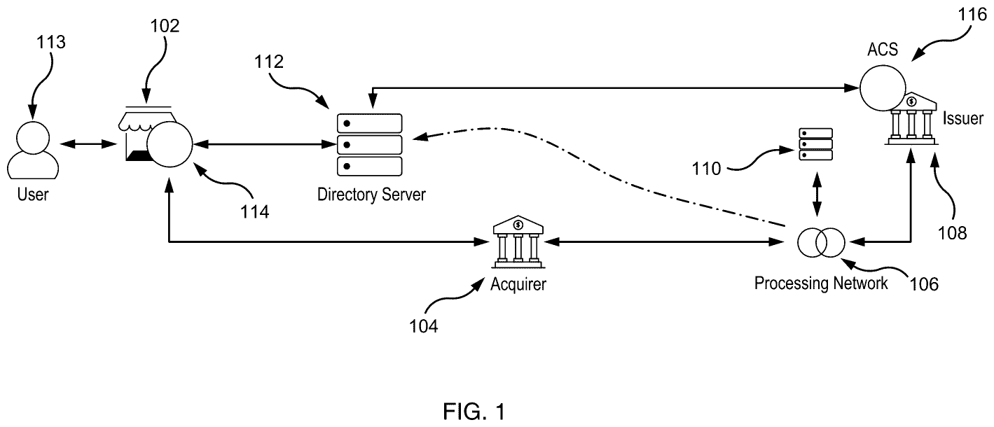

FIG. 1 illustrates an example system 100 that may be utilized for enhanced authentication in verifying a user in connection with a transaction by the user, and which is consistent with the EM V® 3D Secure™ protocol/specification, for example. It should be appreciated, however, that not all details of the EM V® 3D Secure™ protocol/specification for enhanced authentication are discussed herein, yet a complete detailed disclosure of such information may be readily understood by referencing the EM V® 3-D Secure™ protocol/specification and or discussions thereof (see, eg., https://www.emvco.com/emv-technologies/3d-secure/, etc.).

In the illustrated embodiment, the system 100 includes a first party 102, an acquirer 104, a processing network 106, and an issuer 108, each coupled to (and in communication with) one or more networks. The network(s) may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network(s) may include multiple different networks, such as a private payment transaction network made accessible by the processing network 106 to the acquirer 104 and the issuer 108 and, separately, the public Internet, which is accessible as desired to the first party 102, the processing network 106, the issuer 108, and one or more various users in the system 100 (eg., user 113, etc.), etc.

In this example embodiment, the first party 102 may include any party, which accepts payment from users in exchange for goods, services, etc. The first party 102 may therefore include a service provider (eg., for telecommunication, insurance, fitness, food, media, etc., services; etc.), etc. For example, the first party 102 may include an Internet provider, whereby users pay a fee at one or more intervals to access Internet services provided therefrom. The first party 102 may also be considered a merchant, from which goods, services, etc., are purchased. It should be appreciated that the first party 102 should not be understood to be limited to these examples, as other first parties which receive payment for goods, services, etc., may be included in other system embodiments.

Further, the acquirer 104 is a financial institution, such as, for example, a bank, etc., which is configured to issue accounts. The acquirer 104, specifically, has issued an account associated with the first party 102. Similarly, the issuer 108 is a financial institution, which is configured to issue accounts to users, including the user 113. Regardless of the issuer of the account, the accounts are generally associated with an identifier such as, for example, an account number. In this example embodiment, the account issued to the user 113 includes a payment account, such as, for example, a credit account, a debit account, or a prepaid account, which may be used by the user 113 to fund transactions with various parties, including specifically, the first party 102.

In the system 100, the user 113 has previously interacted with the first party 102, whereby the first party 102 is configured to receive a credential associated with the account issued to the user 113 by the issuer 108 and to store the credential in a profile associated with the user 113. In connection therewith, the user 113 agrees to permit the first party 102 to initiate transactions with the credential in exchange for goods, services, etc., from the first party 102.

In this manner, the first party 102 is configured to initiate card-not-present or CNP transactions between the first party 102 and the user 113. Example CNP transactions include recurring transactions for ongoing services, such as, for example, telecommunication services, entertainment subscriptions, etc. In general, the recurring transactions (which may also be CNP transactions) are not initiated by the user 113 (they are initiated by the first party 102), while CNP transactions more generally may or may not be initiated by the user 113.

It should be understood that the payment account credential may include any suitable identifier for the account of the user 113. The credential may include, therefore, a primary account number (PAN), etc. In this example embodiment, the system 100 also includes a token provider 110, which may be internal to the processing network 106 or the issuer 108, or external to each of the processing network 106 and the issuer 108. The token provider 110 is configured to generate tokens for payment accounts and to report tokens to the processing network 106, whereby the processing network 106 is configured to identify routing of token-based messages based on the tokens, similar to the manner by which the processing network 106 is configured to route PAN-based messages based on the PAN. It should be understood that PANs and tokens are broadly referred to herein as credentials.

From time to time, the payment account credential may become invalid for one or more reasons. For example, a payment card bearing the PAN may become stolen, or lost. Or, the token may have been exposed to a bad actor (eg., fraudster, etc.) from one or more sources. In other instances, the payment account credential expires. In some instances, the user 113, for example, reports the situation to the issuer 108, and the issuer 108 is configured to issue a new credential, or the issuer 108 is configured to issue a new credential in advance of expiration of an existing credential.

Regardless, in this example embodiment, the processing network 106 is configured to receive the new credential from the issuer 108 (or the token provider 110) and to provide account updates for CNP transactions.

That is, in response to issuing a new account number for an invalid payment account number, the issuer 108, for example, is configured to inform the processing network 106 of the update. The update may include, without limitation, the old credential and also the new credential. Likewise, in response to issuing a new token for an account, the token provider 110, for example, is configured to inform the processing network 106 of the update. The processing network 106 is configured to receive updated credentials for an account, for which a prior payment account credential has become invalid, and to store the updated credential in a data structure associated with an account update service (not shown). The data structure includes a listing of the invalid credentials and associated updated credentials, whether the credentials are payment account numbers or tokens, etc. The invalid credentials and associated updated credentials may be maintained in the data structure for a period of time, such as, for example, one month, two months, six months, etc., after which the invalid credentials and associated updated credentials are deleted.

It should be appreciated that in one or more embodiments the issuer 108 and/or the token provider 110 may include updated credentials in the data structure (when not part of the processing network 106), apart from the processing network 106.

In the example embodiment, the processing network 106 is configured to update the account credential of the user 113 in response to a transaction, which includes an invalid credential. In connection therewith, the processing network 106 includes a directory server 112, as defined by the 3-D Secure protocol/specification in this example embodiment and which is associated with a first party server plug-in (or MPI) 114 and an access control server (ACS) 116. The MPI 114 is configured as a connection between the first party 102 and the directory server 112, while the ACS 116 is in the issuer domain of 3-D Secure protocols. Each of the MPI 114, the directory server 112 and the ACS 116 is configured to cooperate in connection with enhanced authentication for transactions initiated at the first party 102.

Specifically, in the system 100, at a specific time of a CNP transaction (whether initiated by the user 113 or the first party 102), the first party 102 is configured to process the transaction. In connection therewith, initially, the MPI 114 is configured to compile an authentication request (A Req) for the transaction. The A Req includes the account credential for the account of the user 113, in this example, which may be a PAN or a token, etc. The MPI 114 is configured to then transmit the A Req to the directory server 112.

In this example embodiment, the directory server 112 includes the above-described data structure (of invalid account credentials) and is configured to search in that data structure for the user's account credential. When the account credential is included in the data structure, the account credential is identified as invalid and it is determined that a new, updated account credential has been issued and is included in the data structure in association with the invalid credential.

Consequently, the directory server 112, in a first implementation, is configured to append the new account credential (i.e., the valid account credential) to the A Req and to transmit the A Req to the ACS 116. As such, the director server 1122 provides generally automatic updating of the account credential, directly inline with or part of the authentication phase, for instance, in real time or near real time (e.g., within less than a second, a second, seconds, minutes, etc.), generally as the initial attempt at the transaction is being processed.

In this manner, the ACS 116 is configured to assess a risk of the transaction (eg., based on the amount of the transaction, the first party type involved, the user 113, transaction type (e.g., a recurring payment, etc.), etc.). If the risk is not acceptable (based on the above analysis/authentication), the ACS 116 may be configured to further provide a challenge question to the user 113, consistent with conventional techniques, to authenticate the user 113, or alternatively to decline the transaction, etc. When the user 113 is authenticated, through the above risk-based assessment, or through the additional challenge question, or otherwise, the ACS 116 is configured to then generate an authentication response or A Res and to transmit the A Res to the directory server 112. The A Res includes the new account credential.

Alternatively, in response to the A Req, the directory server 112 (based on identifying the account credential in the data structure), in a second implementation, is configured to compile an A Res, which declines the transaction and includes the new account credential. The directory server 112 is configured to then transmit the A Res to the MPI 114. The MPI 114 (or first party 102) is configured to identify the new account credential, to update the account credential with the new account credential, and to then initiate the transaction again with the new account credential (eg., authentication of the user 113 in the transaction, etc.). Here, in response to the new A Req, the directory server 112 is configured to transmit the A Req to the ACS 116. The ACS 116, in turn, is configured to proceed as is conventional. Again, in this implementation, the account number is updated generally automatically, as part of the authentication phase, for instance, in real time or near real time, as the initial attempt at the transaction is being processed.

In this manner, the ACS 116 is configured to assess a risk of the transaction (eg., based on the amount of the transaction, the first party type involved, the user 113, transaction type (e.g., a recurring payment, etc.), etc.). If the risk is not acceptable (based on the above analysis/authentication), the ACS 116 may be configured to further provide a challenge question to the user 113, consistent with conventional techniques, to authenticate the user 113, or decline the transaction, etc. When the user 113 is authenticated, through the risk-based assessment, or through the additional challenge question, or otherwise, the ACS 116 is configured to then generate an authentication response or A Res and to transmit the same to the directory server 112. The A Res includes the new account credential and also one or more values indicative of the assessment. Thereafter, the ACS 116 is configured to transmit the A Res to the directory server 112.

Upon receipt of the A Res from the ACS 116, the directory server 112 is configured to compile an account authentication value (AAV). The directory server 112 is configured to provide the AAV as part of the A Res to the MPI 114.

In turn, the first party 102 is configured to compile an authorization request for the transaction, which includes the token or the account number for the user's payment account, as appropriate, and also the full AAV. The first party 102 is configured to then transmit the authorization request to acquirer 104. The acquirer 104, in turn, is configured to transmit the authorization request to processing network 106. Upon receipt of the authorization request, the processing network 106 is configured to validate and/or confirm the AAV, or part thereof, etc. Once validated, the processing network 106 is configured to provide the authorization request (including the account number) to the issuer 108.

Then, the issuer 108 is configured to determine if the transaction should be approved or declined, and to respond accordingly, through the processing network 106. The issuer 108 is configured to transmit an authorization response back to the processing network 106. In turn, the processing network 106 is configured to route the authorization response (including the token or the account number) back to the acquirer 104. The acquirer 104, in turn, is configured to provide the authorization response back to the first party 102.

At this point, the transaction is approved (in this example) and the first party 102 may direct the selected product to be delivered to the user 113.

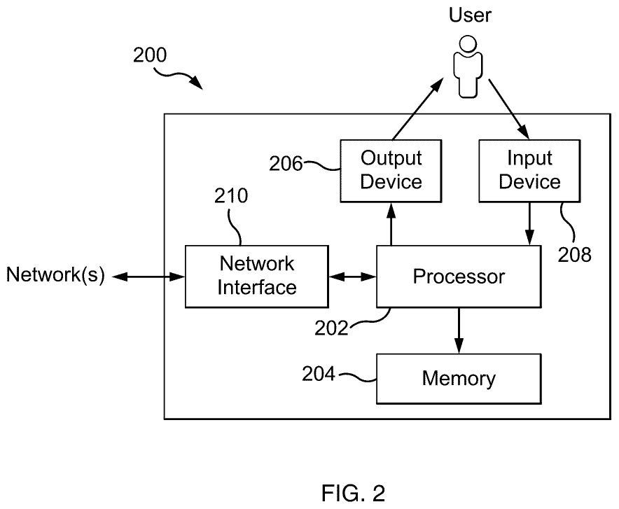

It should be appreciated that each of the issuer 108, the first party 102, the MPI 114, the directory server 112, the ACS 116, the acquirer 104, the issuer 108, and the processing network 106, etc., are implemented herein in one or more computing devices, such as computing device 200 illustrated in FIG. 2. In connection therewith, as described above, the one or more computing devices are each in communication with one or more other entities via one ore more networks. In general, each of the paths included in FIG. 1, along which, or via which, messages are exchanged in the above description are representative of the network(s).

FIG. 2 illustrates the example computing device 200, which may include, for example, one or more servers, workstations, personal computers, laptops, tablets, smartphones, other suitable computing devices, etc. In addition, the computing device 200 may include a single computing device, or it may include multiple computing devices located in close proximity, or multiple computing devices distributed over a geographic region, so long as the computing devices are specifically configured to function as described herein. In at least one embodiment, the computing device 200 is accessed (for use as described herein) as a cloud, fog and/or mist type computing device. With that said, the system 100 should not be considered to be limited to the computing device 200, as described below, as different computing devices and/or arrangements of computing devices may be used. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (eg., in a multi-core configuration, etc.). For example, the processor 202 may include, without limitation, a central processing unit (CPU), a microcontroller, a reduced instruction set computer (RISC) processor, an application specific integrated circuit (A SIC), a programmable logic device (PLD), a gate array, and/or any other circuit or processor capable of the functions described herein.

The memory 204, as described herein, is one or more devices that permits data, instructions, etc., to be stored therein and retrieved therefrom. The memory 204 may include one or more computer-readable storage media, such as, without limitation, dynamic random access memory (DRA M), static random access memory (SRAM), read only memory (ROM), erasable programmable read only memory (EPROM), solid state devices, flash drives, CD-ROM s, thumb drives, floppy disks, tapes, hard disks, and/or any other type of volatile or nonvolatile physical or tangible computer-readable media. The memory 204 may be configured to store, without limitation, IAVs, AAVs, authentication requests, keys, MA Cs, DSRP cryptograms, tokens, account numbers (e.g., PA Ns, etc.), and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 and/or other computer system components configured to perform one or more of the various operations herein. It should be appreciated that the memory 204 may include a variety of different memories, each implemented in one or more of the functions or processes described herein.

In the example embodiment, the computing device 200 also includes an output device 206 that is coupled to (and that is in communication with) the processor 202. The output device 206 outputs information, such as confirmations of purchases, challenge questions, etc., visually, for example, to the user 113 or other information to other users associated with any of the entities illustrated in FIG. 1, at a respective computing device, etc. The output device 206 may include, without limitation, a liquid crystal display (LCD), a light-emitting diode (LED) display, an organic LED (OLED) display, an “electronic ink” display, speakers, etc. In some embodiments, the output device 206 may include multiple devices.

In addition, the computing device 200 includes an input device 208 that receives inputs from the user (i.e, user inputs) such as, for example, responses to challenge questions, checkout inputs, payment account credentials, etc., from the user 113 or other information from other users in the system, etc. The input device 208 may include a single input device or multiple input devices. The input device 208 is coupled to (and is in communication with) the processor 202 and may include, for example, one or more of a keyboard, a pointing device, a mouse, a touch sensitive panel (e.g., a touch pad or a touch screen, etc.), another computing device, and/or an audio input device. Further, in various example embodiments, a touch screen, such as that included in a tablet, a smartphone, or similar device, may behave as both the output device 206 and the input device 208.

The illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks and/or one or more other computing devices herein.

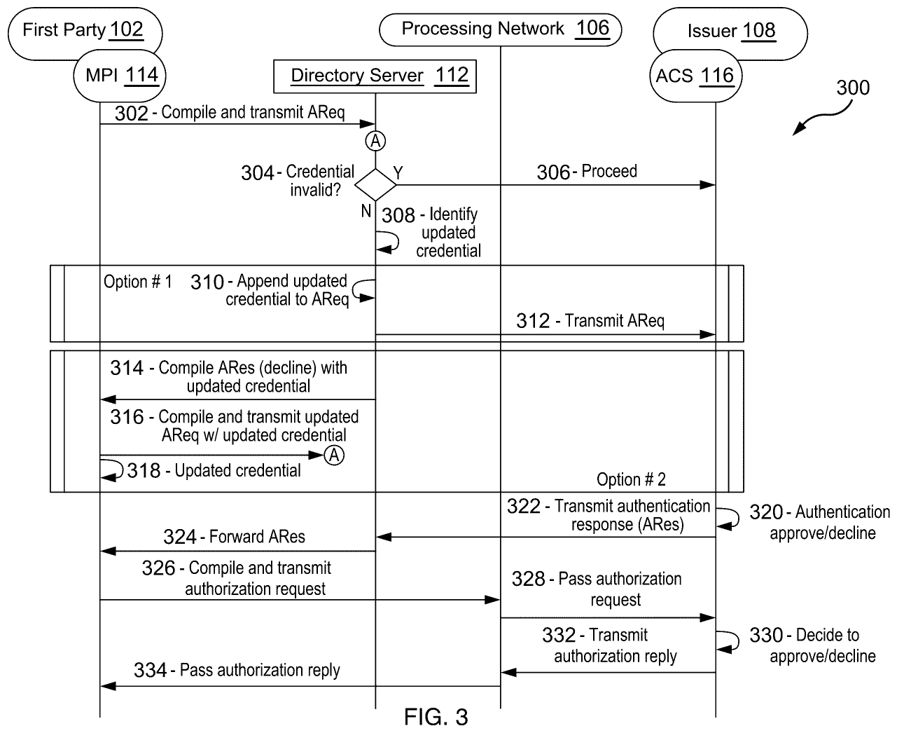

FIG. 3 illustrates an example method 300 for providing updated credentials in response to invalid credentials, as part of transactions. The example method 300 is described (with reference to FIG. 1) as generally implemented in the directory server 112, and the payment network 106 of the system 100, and with further reference to the computing device 200. As should be appreciated, however, the methods herein should not be understood to be limited to the example system 100 or the example computing device 200, and the systems and the computing devices herein should not be understood to be limited to the example method 300.

In the illustrated method 300, for a transaction initiated at the first party 102 (eg., by the user 113 at the first party 102, on behalf of the user 113 by the first party 102, etc.), the first party 102 (i.e., the MPI 114, etc.) compiles and transmits an authentication request (A Req), at 302. The transaction in this example is a CNP transaction, where the user 113 has previously interacted with the first party 102, provided a credential to the first party 102, and given permission for the first party 102 to initiate the CNP transaction. In this manner, the transaction may be a recurring transaction. Alternatively, the user 113 may provide the credential to the first party 102, via a website or other network-based service, whereby the user 113 is not present at the first party 102. The presentation of the credential constitutes permission for the first party 102 to initiate the transaction. In this further example the transaction is again a CNP transaction.

It should be appreciated that in various embodiments, the first party 102 is in possession of the credential associated with the payment account of user 113. In this manner, the credential may be considered to be “on file” with the first party 102 and available for the first party 102 to initiate the transaction (whether based on an interval (eg., monthly, weekly, etc.) or based on the user 113 (eg., an approval by the user 113, etc.)).

The A Req generally includes details of the transaction, such as, for example, the credential associated with the user's account, an amount of the transaction, one or more identifiers of the first party 102, and other suitable data. In this particular example, consistent with method 300, the credential is invalid for one or more reasons, which may include, without limitation, recent fraudulent activity, expiration, loss of a payment card, etc.

As such, in turn in this example, the A Req is received at the directory server 112. In response, at 304, the directory server 112 checks the credential in the A Req for validity. In connection there with, the directory server 112 includes or is in communication with a data structure of invalid credentials. The data structure may include, for example, a listing of the invalid credentials and an associated updated credential. As such, checking the credential for validity may include searching for the credential in the invalid credentials of the data structure.

When the credential is valid, the directory server 112 proceeds, at 306, by forwarding the A Req to the ACS 116, which is business as usual or BAU (and the method 300 generally proceeds at 322).

When the credential is invalid, though, at 308, the directory server 112 identifies the updated credential, from the data structure, for the invalid credential. Next, the directory server 112 has two options, as illustrated in FIG. 3. At Option #1,the directory server 112 appends, at 310, the updated credential to the A Req. The updated credential may be included in place of the invalid credential, or in addition to the invalid credential (and, optionally, denoted as the valid credential, etc.). It should be appreciated that the A Req may be further modified to indicate the presence of the updated credential in one or more examples. Thereafter, the directory server 112 transmits the A Req, at 312, (with the updated credential) to the ACS 116.

At Option #2, in response to identifying the updated credential, the directory server 112 compiles an authentication response (A Res), including a decline of the A Req and the updated credential, at 314. This may include compiling the A Res and then appending the updated credential to the A Res. The A Res is transmitted by the directory server 112 to the first party 102 (i.e., the MPI 114, etc.). In response, the first party 102 identifies the updated credential (as compared to the original credential). The first party 102 then compiles and transmits, at 316, an updated authentication request (A Req) to the directory server 112. As illustrated in FIG. 3, the updated A Req is received at point A in the method 300, consistent with how the directory server 112 receives any other authentication request (as described above).

In addition, at 318, the first party 102 updates the stored credential to include the updated credential, rather than the original credential. In this way, further transactions directed to the account will generally include the updated credential.

Next in the method (generally independent of the options described above), at 320, the ACS 116 decides whether to approve or decline the authentication (eg., based on receipt of, or in response to, the A Req with the valid credential, etc.). The approval or decline of the authentication may be based on the data included in the A Req and/or historical data related to the credential or other credentials. In turn, at 322, the ACS 116 compiles and transmits an authentication response (A Res) to the directory server 112. The A Res may include the updated credential, optionally, and an indicator of the updated credential (eg., a set flag, etc.).

Next, the directory server 112 may generate one or more values (eg., an AAV, etc.) and append the same to the A Res and then, at 324, transmits the A Res to the first party 102, and specifically, to the MPI 114.

The first party 102 may then store the updated credential, if desired, or if not previously stored. In turn, as shown in FIG. 3, the first party 102 compiles and transmits, at 326, an authorization request for the CNP transaction to the processing network 106 (e.g., via the acquirer 104, etc.). The compiled authorization request generally includes the updated credential and other data conventionally found in an authorization request (eg., first party ID, name, transaction amount, MCC, date, time, etc.).

Upon receipt of the authorization request, the processing network 106 may validate one or more values included in the authorization request (e.g., the AAV, etc.), and when validated, pass the authorization request to the issuer 108, at 328. The issuer 108 then decides, at 330, to approve or decline the transaction. The issuer 108 may rely on any conventional or other basis (e.g., based on whether the user's payment account is in good standing, whether the payment account includes sufficient funds/credit, fraud scoring, etc.) to approve or decline the transaction. Next, at 332, the issuer 108 compiles and transmits an authorization reply to the processing network 106. The processing network 106, in turn, passes, at 334, the authorization reply to the first party 102 (eg., via the acquirer 104, etc.). The first party 102 may then deliver a product or service to the user 113, update an account associated with the user 113 indicating the transaction, or otherwise proceed, etc.

In view of the above, the systems and methods herein provide generally automatic updating of credentials associated with accounts (eg., invalid credentials, etc.), in line with authentications associated with transactions to the accounts identified by the credentials (generally as the transactions are taking place and/or being processed, etc.) (e.g., in real time or near real time, etc.). That is, the updating of the credentials is integrated into an existing flow, apart from authorization of the transaction, whereby the updating of the credential is essentially transparent to the user associated with the account as well as the first parties involved in the transactions. What's more, the first parties initiating the transactions are immediately permitted to proceed in the transactions without interacting with the users to obtain the updated credentials (eg., in response to declined authorizations of the transactions based on outdated or invalid credentials, etc.), and without having to separately secure the updated credentials for the transactions from the users or the issuers of the updated credentials. This creates efficiencies in the flow of data in the described processing network, whereby unnecessary network traffic due to repeated submissions of the same transaction, is avoided.

Further, because the updated credentials are automatically secured as part of (and in line with) the authentication process (and prior to the authorization process for the transactions), the first parties are automatically informed of the updated credentials in connection with the transactions. What's more, the correct/updated credentials are also automatically included in the subsequent authorization phase for the transactions (again, without the users, first parties, issuers, etc. having to provide the same). This necessarily results in a reduction in network traffic in coordinating authorization of the transactions. In particular, the messaging related to the transaction, after the update from the directory server, is updated with the new credential. As such, the messaging transmitted through the remainder of the authorization phase and transmitted through the processing networks automatically include the updated credentials, through the technical implementation herein, whereby unnecessary messaging declining transactions based on the invalid credentials and/or the subsequent re-initiating of the transaction is avoided and eliminated (where such additional messaging is added/unnecessary traffic in view of the present disclosure, which adversely impact network performance). In other words, the present disclosure avoids such excess (or extra) network traffic in the form of declined and repeated transactions, thereby improving performance of the networks processing messages overall through reduced network traffic.

A gain, and as previously described, it should be appreciated that the functions described herein, in some embodiments, may be described in computer executable instructions stored on a computer-readable media, and executable by one or more processors. The computer-readable media is a non-transitory computer-readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving, from a first party, an authentication request for a network transaction associated with an account, the authentication request including a credential unique to the account; (b) determining that the credential unique to the account is invalid; and/or (c) in response to determining that the credential unique to the account is invalid: (i) identifying an updated credential unique to the account; (ii) appending the updated credential unique to the account to an authentication message; and/or (iii) transmitting the authentication message to one of the first party and an access control server (ACS) associated with an issuer of the account.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112 (f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for use in updating credentials for accounts associated with users, the system comprising:
a directory server configured to:
receive, from a first party, an authentication request for a network transaction associated with an account, the authentication request including a credential unique to the account;
determine that the credential unique to the account is invalid;
in response to determining that the credential unique to the account is invalid:
identify an updated credential unique to the account;
append the updated credential unique to the account to an authentication message; and
transmit the authentication message to one of the first party and an access control server (ACS) associated with an issuer of the account.

2. The system of claim 1, wherein the credential includes one of a primary account number (PAN) and a token associated with the PAN.

3. The system of claim 1, wherein the authentication message is the authentication request; and
wherein the directory server is configured to transmit the authentication message to the ACS.

4. The system of claim 3, wherein the directory server is further configured to:
receive an authentication response from the ACS, the authentication response including the updated credential; and
transmit the authentication response to the first party.

5. The system of claim 1, wherein the authentication message includes an authentication response; and
wherein the directory server is configured to transmit the authentication message back to the first party, thereby permitting the first party to submit a subsequent authentication request with the updated credential.

6. The system of claim 1, wherein the directory server is configured, in determining that the credential unique to the account is invalid, to search in a data structure for the credential; and
wherein the data structure includes a listing of invalid credentials and associated updated credentials.

7. The system of claim 6, wherein the directory server is configured, in identifying the updated credential, to identify the updated credential associated with the invalid credential in the data structure.

8. The system of claim 1, further comprising a processing network, which is configured to receive an authorization request for the network transaction from the first party and to transmit the authorization request to the issuer of the account; and
wherein the authorization request includes an amount of the network transaction, the updated credential, and a value based on data received from the ACS for the network transaction.

9. The system of claim 1, wherein the directory server is configured consistent with the 3D Secure protocol/specification for enhanced authentication.

10. A non-transitory computer-readable storage medium comprising executable instructions for updating credentials for accounts associated with users, which when executed by at least one processor of a directory server, cause the at least one processor to:
receive, from a first party, an authentication request for a network transaction associated with an account, the authentication request including a credential unique to the account;
determine that the credential unique to the account is invalid;
in response to determining that the credential unique to the account is invalid:
identify an updated credential unique to the account;
append the updated credential unique to the account to an authentication message; and
transmit the authentication message to one of the first party and an access control server (ACS) associated with an issuer of the account.

11. The computer-readable storage medium of claim 10, wherein the credential includes one of a primary account number (PAN) and a token associated with the PAN.

12. The computer-readable storage medium of claim 10, wherein the authentication message is the authentication request; and
wherein the executable instructions, when executed by the at least one processor, cause the at least one processor to transmit the authentication message to the ACS.

13. The computer-readable storage medium of claim 12, wherein the executable instructions, when executed by the at least one processor, further cause the at least one processor to:
receive an authentication response from the ACS, the authentication response including the updated credential; and
transmit the authentication response to the first party.

14. The computer-readable storage medium of claim 10, wherein the authentication message includes an authentication response; and
wherein the executable instructions, when executed by the at least one processor, cause the at least one processor to transmit the authentication message back to the first party, thereby permitting the first party to submit a subsequent authentication request with the updated credential.

15. The computer-readable storage medium of claim 10, wherein the executable instructions, when executed by the at least one processor, cause the at least one processor, in determining that the credential unique to the account is invalid, to search in a data structure for the credential; and
wherein the data structure includes a listing of invalid credentials and associated updated credentials.

16. The computer-readable storage medium of claim 15, wherein the executable instructions, when executed by the at least one processor, cause the at least one processor, in identifying the updated credential, to identify the updated credential associated with the invalid credential in the data structure.

17. The computer-readable storage medium of claim 10, wherein the executable instructions are consistent with the 3D Secure protocol/specification for enhanced authentication.

18. A computer-implemented method for use in updating credentials for accounts associated with users, the method comprising:
receiving, by a computing device of a directory server, from a first party, an authentication request for a network transaction associated with an account, the authentication request including a credential unique to the account;
determining, by the computing device of the directory server, that the credential unique to the account is invalid; and
in response to determining that the credential unique to the account is invalid:
identifying an updated credential unique to the account;
appending the updated credential unique to the account to an authentication message; and
transmitting the authentication message to one of the first party and an access control server (ACS) associated with an issuer of the account.

19. The computer-implemented method of claim 18, further comprising:
receiving an authentication response from the ACS, the authentication response including the updated credential;
transmitting the authentication response to the first party; and then,
receiving, by a processing network computing device, an authorization request for the network transaction from the first party; and
transmitting, by the processing network computing device, the authorization request to the issuer of the account; and
wherein the authorization request includes an amount of the network transaction, the updated credential, and a value based on data received from the ACS for the network transaction.

20. The computer-implemented method of claim 19, wherein the credential includes one of a primary account number (PAN) and a token associated with the PAN.
